(19) United States
(12) Patent Application Publication
(10) Pub. No.: US 2018/0082370 A1
(43) Pub. Date: Mar. 22, 2018

(54) CREDIT CARD PRODUCT WITH DYNAMIC INTEREST RATE BASED ON BALANCE/SPENDING IN MERCHANT CATEGORIES

(71) Applicant: MasterCard International Incorporated, Purchase, NY (US)

(72) Inventor: Girish Pandey, Valhalla, NY (US)

(21) Appl. No.: 15/271,952

(22) Filed: Sep. 21, 2016

(51) Int. Cl. G06Q 40/02; G06Q 20/10

(52) U.S. Cl. CPC G06Q 40/025; G06Q 20/102

(57) ABSTRACT

A method includes establishing a credit account, setting a first interest rate and setting a second interest rate. The first interest rate is applicable to a first category of transactions charged to the credit account. The second interest rate is applicable to a second category of transactions charged to the credit account. The second category of transactions is different from the first category of transactions. The second interest rate is different from the first interest rate.

### BACKGROUND

Payment accounts such as credit card accounts, debit card accounts, and prepaid card accounts are in widespread use. In one conventional manner of accessing a payment account, the account holder presents a plastic card at the point of sale in a retail store. The point of sale device reads account information from the card (e.g., via a magnetic stripe or through wireless communication with an integrated circuit in the card, or via electrical contacts on the card) and initiates a payment account system transaction using the information read by the card.

When the payment account is a credit card account, a monthly statement is typically rendered by the issuer of the account to the account holder to indicate what charges have been recorded for the account, and what amount is owed from the account holder to the issuer. Typically, if the account holder had timely paid the entire balance due on the account in the previous statement cycle, then the current statement will not indicate that any interest charges are due. However, if the account holder did not pay the entire outstanding balance in the previous cycle, then an interest charge on the unpaid balance from the previous statement would usually be applied in the current statement.

The interest rate at which unpaid balances accrue interest charges may be set by the account issuer based on a number of factors. One well known factor to be used is the amount of credit risk represented by the account holder. Often this credit risk is determined based on the account holder's ability to pay, as indicated by, for example, one or more credit reports obtained by the account issuer with respect to the account holder.

The present inventor has now recognized an opportunity to improve interest rate setting for credit card balances by considering information that may reflect the account holder's willingness to pay as well as his/her ability to pay.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates features of a payment system provided in accordance with aspects of the present disclosure.

FIG. 3 is a block diagram that illustrates a computer system that may be operated as part of the system of FIG. 2 and in accordance with aspects of the present disclosure.

FIG. 4 is a flow chart that illustrates a process that may be performed by the computer system of FIG. 3 in accordance with aspects of the present disclosure.

FIG. 5 is a simplified example of a monthly account statement that may be issued to an account holder by the computer system of FIG. 3 in accordance with aspects of the present disclosure.

### DETAILED DESCRIPTION

In general, and for the purpose of introducing concepts of embodiments of the present disclosure, a blended interest rate may be applied to unpaid balances in a credit card account. The blended rate may be calculated based on two or more interest rates that are applicable to different categories of purchases. In some embodiments, the categories of purchases may be inferred from the merchant categories that are applicable to the transactions that are charged to the account. So-called “top of wallet” transactions such as supermarket purchases, utility bill payments, gasoline purchases, etc. may be deemed to be associated with a high willingness to pay on the part of the account holder, and so may be assigned a relatively low interest rate. Discretionary or less financially prudent purchases, such as gambling transactions, big-ticket electronics purchases or purchases from liquor stores, may be deemed to be associated with a lower willingness to pay, and so may be assigned a somewhat higher interest rate. In this way the applicable interest rate may, in an automatic way, be adjusted to account for potential credit risk related to the account holder's willingness to pay, in addition to reflecting ability to pay. The automatic adjustment may reflect the nature of the purchases that make up the credit card account's revolving balance.

In some embodiments, only two categories of transactions, and only two interest rates (one applicable to each of the two categories of transactions) may be utilized for the blended rate calculation. In other embodiments, three, four or more different categories of transactions, and a corresponding number of category-relevant interest rates, may be employed in the blended rate calculation. It is within the contemplation of the invention for an account issuer to evaluate risk related to willingness to pay down to the level of individual merchant category codes (“MCCs”), and accordingly to assign a different interest rate according to the MCC that applies to a given transaction.

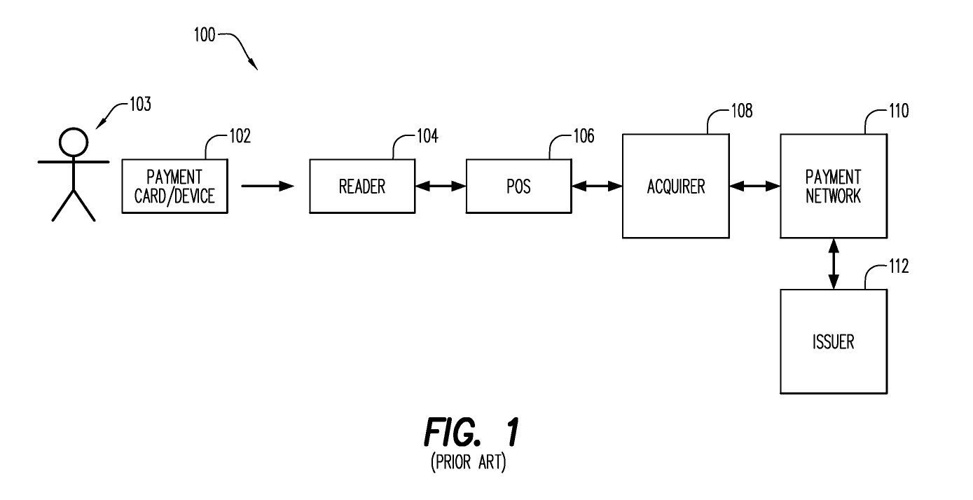

By way of background, a conventional payment system will first be briefly described. FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc. The payment card/device 102 is shown being carried and used by an account holder/user 103.

The system 100 further includes a reader component 104 associated with a POS terminal 106. In some known manner (depending on the type of the payment card/device 102) the reader component 104 is capable of reading the payment card account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment card account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users. For example, the payment account issuer server computer 112 may perform such functions as (a) receiving and responding to requests for authorization of payment card account transactions to be charged to payment accounts issued by the FI; (b) tracking and storing transactions and maintaining account records; (c) rendering periodic account statements; and (d) receiving and tracking payments to the issuer from the account holders.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number to the reader component of a POS terminal.

In further aspects of the conventional payment system 100, not explicitly indicated in the drawing, the function of the POS terminal 106 may be performed by an unattended device, such as (a) a self-service gasoline pump that includes payment card reading capabilities, or (b) a transit system kiosk that issues or refills transit cards or similar devices while reading payment cards and initiating payment transaction authorization requests to obtain payment for the transit cards/refills.

Still further, and as is well-known, for e-commerce transactions, an e-commerce server computer (not shown) may function as the POS terminal. The e-commerce server computer may be operated by or on behalf of a merchant and may be accessed by the account holder via a browser program running on (for example) a personal computer (not shown) or a smartphone (not shown apart from payment device 102). To arrange for the payment portion of the e-commerce transaction, the account holder may manually enter a payment account number, or authorize a charge from a payment account number held on file by the merchant, or access a digital wallet, etc.

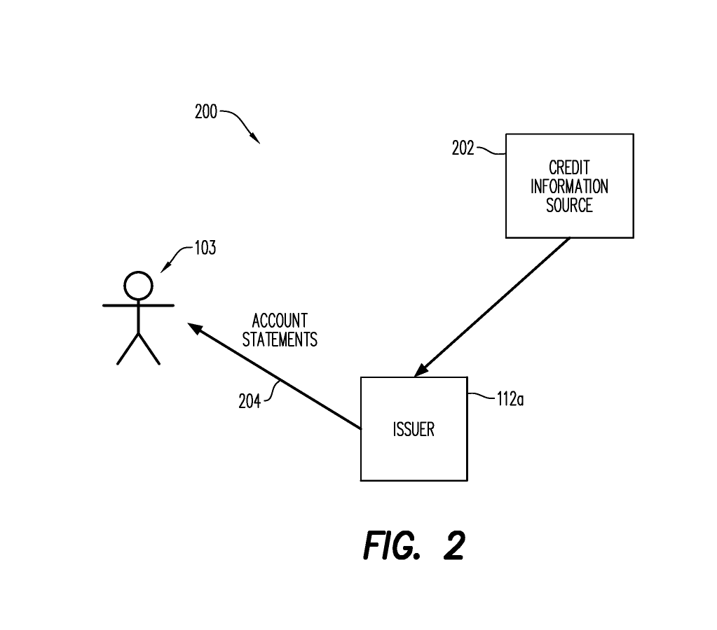

FIG. 2 is a block diagram that illustrates a payment system 200 provided in accordance with aspects of the present disclosure. As was the case in FIG. 1, the payment system is depicted in FIG. 2 only in terms of components needed for a single transaction; in practice, the payment system 200 may include many more instances of at least some components. (It should also be noted that the system 200 may include all components shown in FIG. 1, although many such components are omitted from FIG. 2 in order to simplify the drawing.)

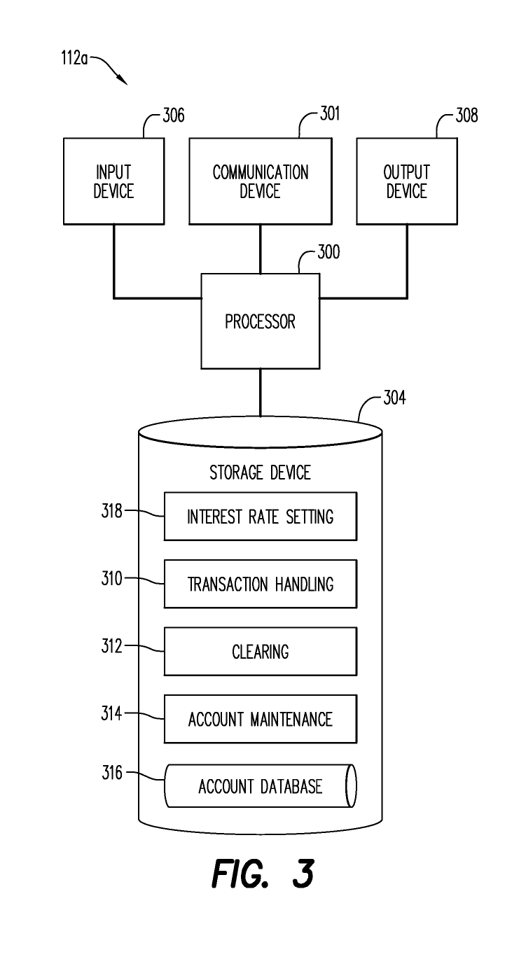

The payment system 200 includes an account issuer server computer 112a, which may provide all of the functionality of the conventional issuer server 112 referred to above in connection with FIG. 1. In addition to its conventional functionality, the account issuer server computer 112a may—in accordance with aspects of the present disclosure—calculate and apply blended interest rates to outstanding revolving credit card account balances, in a manner described herein. Further details of the account issuer server computer 112a and the functions it performs will be described below, including the discussion below of FIGS. 3-5.

Continuing to refer to FIG. 2, the account issuer server computer 112a is shown obtaining credit report information from a credit information source 202 (e.g., from one of the well-established credit bureaus). Moreover, as indicated at 204, the account issuer server computer 112a is shown providing periodic credit card account statements to the account holder/user 103. The periodic account statements may reflect charging of blended interest rates as described herein. The account statements may be provided electronically and/or on paper (by postal mail).

FIG. 3 is a block diagram that illustrates an example embodiment of the account issuer server computer 112a as shown in FIG. 2 and provided in accordance with aspects of the present disclosure.

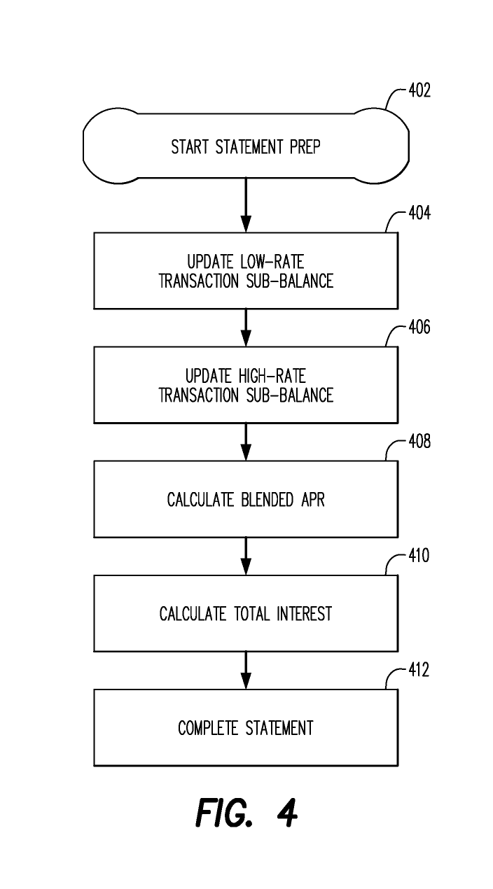

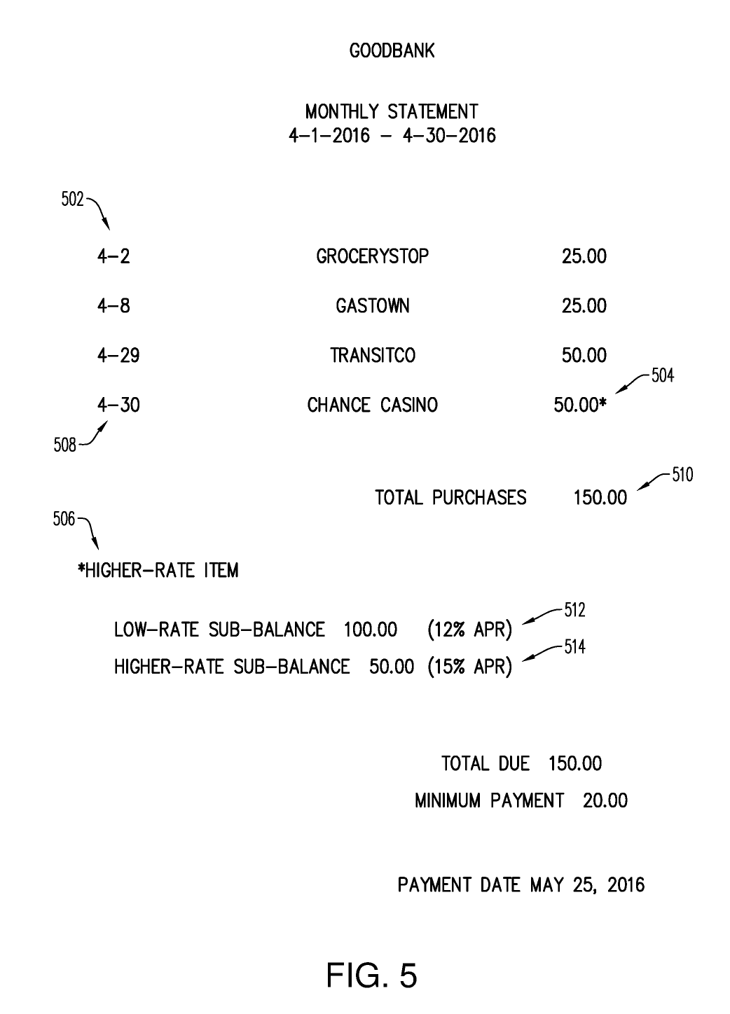

As noted above, the account issuer server computer 112a may provide all of the functionality of the issuer computer 112 shown in FIG. 1, including handling of transaction authorization request messages and generating responses to such messages. In addition, the account issuer server computer 112a may provide—in accordance with aspects of the present disclosure—functionality relating to calculating and applying blended interest rates to unpaid revolving credit card account balances. Details of such functionality will be described below, including the discussion below of FIGS. 4 and 5.

Referring now to FIG. 3, the account issuer server computer 112a may, in its hardware aspects, resemble a typical server computer, but may be controlled by software to cause it to function as described herein.

The account issuer server computer 112a may include a computer processor 300 operatively coupled to a communication device 301, a storage device 304, an input device 306 and an output device 308. The communications device 301, the storage device 304, the input device 306 and the output device 308 may all be in communication with the processor 300.

The computer processor 300 may be constituted by one or more processors. Processor 300 operates to execute processor-executable steps, contained in program instructions described below, so as to control the account issuer server computer 112a to provide desired functionality.

Communication device 301 may be used to facilitate communication with, for example, other devices (such as other components of the payment system 200, as well as mobile devices and/or computing devices operated by account holders). Communication device 301 may comprise numerous communication ports (not separately shown), to allow the account issuer server computer 112a to communicate simultaneously with a number of other computers and other devices, including communications as required to simultaneously handle numerous interactions with other devices referred to in connection with FIG. 2.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the account issuer server computer 112a, executed by the processor 300 to cause the account issuer server computer 112a to function as described herein.

The programs may include one or more conventional operating systems (not shown) that control the processor 300 so as to manage and coordinate activities and sharing of resources in the account issuer server computer 112a, and to serve as a host for application programs (described below) that run on the account issuer server computer 112a.

The programs stored in the storage device 304 may include, for example, a transaction handling application program 310. The transaction handling application program 310 may generally operate in accordance with typical operating practices of issuer servers in a payment system as described in connection with FIG. 1.

Another program that may be stored in the storage device 304 is a clearing operations application program 312. This program may in general operate in accordance with typical practices for clearing and settlement of payment account transactions.

The storage device 304 may further store an account maintenance application program 314 and an account database 316. The account maintenance application program 314 and the account database 316 may be provided in accordance with customary approaches for such program/data structures.

Still further, the storage device 304 may store an interest rate setting program 318. The interest rate setting program 318 may program the processor 300 so as to operate in accordance with teachings of the present disclosure in terms of providing blended interest rates that reflect the mix of transactions charged to individual credit card accounts. In some embodiments, for example, the interest rate setting program 318 may cooperate with the account maintenance application program 314 in connection with preparation of account statements for individual credit card accounts. Details of the interest rate setting program 318 will be provided below.

FIG. 4 is a flow chart that illustrates a process that may be performed by the account issuer server computer 112a in accordance with aspects of the present disclosure. In particular, FIG. 4 illustrates a process that may be performed to generate a monthly (or other periodic) account statement for a given credit card account. It is to be understood that such a process may be performed at regular intervals for every credit card account issued by the account issuer and subject to application of a blended interest rate in accordance with teachings of this disclosure.

Block 402 in FIG. 4 represents the account issuer server computer 112a commencing preparation of a monthly statement for a particular credit card account, say account number 5555444433332222. It will be assumed that after the payment received for the previous billing cycle, the unpaid principal balance on the account was $100.00, made up of (a) a first sub-balance of $80.00 corresponding to previous “top of wallet” purchases to which an interest rate of 12% APR was applicable; and (b) a second sub-balance of $20.00 corresponding to previous “discretionary” purchases to which an interest rate of 15% APR was applicable. It will also be assumed that upon opening of account no. 5555444433332222, the account holder was notified in advance by the account issuer that the 12% rate would be applied to the former category of purchase transactions, and that the 15% rate would be applied to the latter category of purchase transactions.

It will further be assumed that a total of $70.00 was made in purchase transactions during the current cycle, including $60.00 of purchases that fall in the “top of wallet” category and $10.00 of purchases that fall in the “discretionary” category.

At block 404, the account issuer server computer 112a updates the “top of wallet” sub-balance to reflect the purchases in that category in the current cycle. At block 406, the account issuer server computer 112a updates the “discretionary” sub-balance to reflect the purchases in that category in the current cycle. The following simple additive formula may be applied:

CS_{updated}=CSₚᵣₑᵥᵢₒᵤₛ+CP_{current} (Eq. 1)

, where CS means Category Sub-Balance; and
CP means Category Purchases.

As a result of steps 404 and 406, the updated Category Sub-Balance for the “top of wallet” category is calculated as $80.00+$60.00=$140.00. Similarly, the updated Category Sub-Balance for the “discretionary” category is calculated as $20.00+$10.00=$30.00. The total principal balance (TPB) is now $170.00 (=$140.00+$30.00).

Next, at step 408, the blended interest rate to be applied to the TPB, according to aspects of the present disclosure, may be calculated according to the following formula:

BR=(R_{TOW}*(CS_{updated-TOW}/TPB))+(R_{D}*(CS_{updated-D}/TPB)) (Eq. 2)

, where BR stands for Blended Rate;
R stands for the applicable category interest rate;
the subscript (or subscript component) TOW stands for “top of wallet”;
the subscript (or subscript component) D stands for “discretionary”.

Applying this formula to the numerical example stated above produces:

BR=(12%*(140.00/170.00))+(15%*(30.00/170.00))=12.52% APR.

In a following step (block 410), the blended rate BR may be applied in an essentially conventional manner to the TPB to calculate the interest due on the principal balance.

Following block 410 in FIG. 4 is block 412. At 412, the account issuer server computer 112a completes preparation of the monthly statement for account no. 5555444433332222, in a manner that reflects the interest calculation as described above, including calculation of the blended rate.

When payments are credited to the credit card account, the allocation of the payments to principal may be made to the category sub-balances in proportion to the amounts of the category sub-balances. If the total amount due is paid off, then all category sub-balances may be reduced to zero, and accordingly the nature of past transactions may cease to have any effect on the interest rate to be applied to subsequent purchases. From that point forward (until the next payment in full of an open balance), calculation of the blended interest rate will be based on the current and/or residual categories in which the purchase transactions fall.

FIG. 5 is a simplified example of a monthly statement that may be provided to a customer by the account issuer server computer 112a. For purposes of the explanation and presentation of FIG. 5, a new numerical example is introduced, which departs from the numerical example used above to discuss the process of FIG. 4.

It is assumed for the simplified example statement shown in FIG. 5 that the customer had paid off the balance from the previous billing cycle, so that no balance is carried over to the present cycle or indicated in the statement.

At 502 in FIG. 5, a list of charges to the customer's credit card account is presented. An indication at 504 and an explanatory note at 506 indicate to the customer that the fourth line item 508 represents a transaction in a higher rate category.

The total of purchase transactions is indicated at 510. The “top of wallet” sub-balance is shown at 512, and the “discretionary” sub-balance is shown at 514, in both cases in conjunction with the category-relevant interest rate that is applicable to the respective sub-balance.

If the customer pays off the total amount due, it may be expected that the account issuer's practice is not to apply any interest charges. If the customer pays less than the total balance, then a blended interest rate may be applied to the unpaid balance. The blended interest rate to be applied may be calculated in accordance with the teachings provided above in connection with FIG. 4. For example, Equation (2) may be applied.

In examples given above, only two categories of transactions were established for purposes of adjusting the applicable interest rate to the apparent risk due to potential unwillingness to pay. However, in other embodiments, three or more categories may be established, each with a different applicable category interest rate. Those who are skilled in the art would readily understand, from the above teachings of this disclosure, how to adapt Equations (1) and (2) to embodiments in which three or more categories of transactions are established.

With monthly calculation of a blended interest rate as described herein, the interest rate charged on a credit card account balance may be dynamically adjusted to reflect dynamic changes in the amount of credit risk associated with the account in question. Consequently, the account issuer may more precisely match the effective interest rate to the effective risk borne by the account issuer.

In some embodiments, the account issuer may out-source the dynamic rate calculation function to a service bureau that is operated, e.g., by the operator of the payment network.

In embodiments described above, transactions were categorized for rate-calculation purposes based on the category of the merchant involved in the respective transaction. In addition or alternatively, if product level information is reported, such information may also be taken into account in categorizing transactions for rate-calculation purposes. In addition or alternatively, the amount of the transaction may also be considered in categorizing transactions for rate-calculation purposes.

As an example of the foregoing, a transaction at a “big-box” electronics merchant may be deemed “discretionary”/higher risk if it is large (say more than $500.00), but otherwise may be subject to the same interest rate as “top of wallet” purchases. As another example, if a transaction is known (based on product level information conveyed to the account issuer) to be for a wide-screen television set or for home-theater equipment, such a transaction may be categorized as “discretionary.”

In some embodiments, an account issuer may analyze how its credit risk/loss experience correlates with various categories of spending. Based on such an analysis, the account issuer may set up categories of purchase transactions to match higher applicable interest rates to types of spending found to be associated with higher risk.

As used herein and in the appended claims, the term “set of merchant classes” refers to one merchant class or category or more than one merchant class or category.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of method steps.

As used herein and in the appended claims, the term “payment card system account” includes a credit card account, a deposit account that the account holder may access using a debit card, a prepaid card account, or any other type of account from which payment transactions may be consummated. The terms “payment card system account,” “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
establishing a credit account;
setting a first interest rate, the first interest rate applicable to a first category of transactions charged to the credit account; and
setting a second interest rate, the second interest rate applicable to a second category of transactions charged to the credit account, the second category of transactions different from the first category of transactions, the second interest rate different from the first interest rate.

2. The method of claim 1, wherein:
the first category of transactions is defined at least in part in terms of a first set of merchant classes; and
the second category of transactions is defined at least in part in terms of a second set of merchant classes, the second set of merchant classes different from the first set of merchant classes.

3. The method of claim 2, wherein:
the first set of merchant classes includes grocery stores; and
the second set of merchant classes includes gambling establishments.

4. The method of claim 3, wherein the first interest rate is lower than the second interest rate.

5. The method of claim 1, wherein the second category of transactions is defined at least in part based on transaction amount.

6. The method of claim 1, wherein the second category of transactions is defined at least in part based on a type of merchandise or service purchased.

7. The method of claim 1, wherein the second category of transactions is defined based on both a merchant category and a transaction amount pertaining to a given transaction.

8. The method of claim 1, wherein the credit account is a credit card account.

9. The method of claim 8, wherein a periodic statement for the credit card account indicates: (a) the first and second interest rates, (b) a total sub-balance amount corresponding to the first category of transactions, and (c) a total sub-balance amount corresponding to the second category of transactions.

10. The method of claim 9, wherein, for at least one transaction entry listed on the periodic account statement, an indication is provided that the at least one transaction entry corresponds to the second category of transactions.

11. An apparatus comprising:
a processor; and
a memory in communication with the processor, the memory storing program instructions, the processor operative with the program instructions to perform functions as follows:
establishing a credit account;
setting a first interest rate, the first interest rate applicable to a first category of transactions charged to the credit account; and
setting a second interest rate, the second interest rate applicable to a second category of transactions charged to the credit account, the second category of transactions different from the first category of transactions, the second interest rate different from the first interest rate.

12. The apparatus of claim 11, wherein:
the first category of transactions is defined at least in part in terms of a first set of merchant classes; and
the second category of transactions is defined at least in part in terms of a second set of merchant classes, the second set of merchant classes different from the first set of merchant classes.

13. The apparatus of claim 12, wherein:
the first set of merchant classes includes grocery stores; and
the second set of merchant classes includes gambling establishments.

14. The apparatus of claim 13, wherein the first interest rate is lower than the second interest rate.

15. The apparatus of claim 11, wherein the second category of transactions is defined at least in part based on transaction amount.

16. The apparatus of claim 11, wherein the second category of transactions is defined at least in part based on a type of merchandise or service purchased.

17. The apparatus of claim 11, wherein the second category of transactions is defined based on both a merchant category and a transaction amount pertaining to a given transaction.

18. A non-transitory storage medium storing program instructions, the program instructions operable to control a machine to perform functions as follows:
establishing a credit account;
setting a first interest rate, the first interest rate applicable to a first category of transactions charged to the credit account; and
setting a second interest rate, the second interest rate applicable to a second category of transactions charged to the credit account, the second category of transactions different from the first category of transactions, the second interest rate different from the first interest rate.

19. The storage medium of claim 18, wherein:
the first category of transactions is defined at least in part in terms of a first set of merchant classes; and
the second category of transactions is defined at least in part in terms of a second set of merchant classes, the second set of merchant classes different from the first set of merchant classes.

20. The storage medium of claim 19, wherein:
the first set of merchant classes includes grocery stores; and
the second set of merchant classes includes gambling establishments.
